(19) United States
(12) Patent Application Publication
(10) Pub. No.: US 2007/0005501 A1
(43) Pub. Date: Jan. 4, 2007

(54) Method for monitoring and controlling a number of available decentralized ip budgets of a subscriber in a packet-based communications network during an online assessment of charges with limit value monitoring for data transmissions

(75) Inventors: Uwe Foll, Falkensee (DE); Wolfgang Hahn, Bergfelde (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munich (DE)

(21) Appl. No.: 10/552,280

(22) PCT Filed: Apr. 4, 2003
(86) PCT No.: PCT/DE03/01226

§ 371 Date: Oct. 4, 2005

(51) Int. Cl. G06Q 99/00

(52) U.S. Cl. 705/52

(57) ABSTRACT

The invention relates to a method for monitoring and controlling a number of available decentralized IP budgets of a subscriber in a packet-based communications network during an online assessment of charges for data transmissions. According to the invention, the number of available IP budgets are each allocated in a data flow-specific manner to a data flow in a context that can be assigned to the subscriber, and a higher-order control function is provided in a network node of the communications network. Said higher-order control function charges the data flow-specific IP budget according to a resource use of a data flow based on charge assessment specifications issued by a charge assessing computer during a resource use of the data flow in a context that can be assigned to the subscriber, and effects a partial or complete transmission of the IP budget between selected data flows in a case-related manner.

### CLAIM FOR PRIORITY

This application is a national stage of PCT/DE2003/001226, published in the German language on Oct. 28, 2004, which was filed on Apr. 4, 2003.

### TECHNICAL FIELD OF THE INVENTION

The invention relates to a method for monitoring and controlling a number of available decentralized IP budgets, and in particular, to time, transmission volume, number of packets, of a subscriber in a packet-based communications network during an online assessment of charges with limit value monitoring for data transmissions.

### BACKGROUND OF THE INVENTION

WO02/096025A discloses a packet-based communications network in which value-added services are implemented and assessed for charges.

U.S. Pat. No. 995,822 discloses a performance-based communications network in which a number of separate circuit-switched telephone connections of a subscriber may be assessed for charges online.

Communication procedures that are based on the transmission of data packets (e.g. IP packets, IP=Internet Protocol) are often used in wireless and wired communications networks. These procedures are therefore known as packet-based communications networks. A packet-based communications network may, for example, be a third-generation mobile telephone network, which operates according to GPRS specifications (GPRS=General Packet Radio System). In packet-based mobile telephone networks, call charge registration is based—among other things—on registration of the IP packets transmitted. These charges are calculated from the total volume of IP packets transmitted to and from a subscriber, the number of IP packets, or the number of data bytes. The charges may also be determined on the basis of the transmission time. This use of resources is referred to in this invention as the IP budget. Existing online charge services for GPRS are based on monitoring of the IP budget within a PDP context. A PDP context is an example of a so-called Layer 2 connection from a subscriber to the communications network. All charge-related data that refers to a context is registered and compared to an IP budget specified for this context by a charge assessing computer, known as an online charging server. The budget made available for a data flow by the charge-assessing computer is determined by current parameters, such as—for example—a subscriber credit, an available bandwidth, or by a quality requirement (QoS) of a data flow. A number of these data flows may be located within a Layer 2/PDP context. A budget that is specifically made available is always tied to the parameters of a data flow. If a budget makes 300 kbytes available, for example, then this budget can only be used for a data flow with the specified bandwidths or quality requirements. If the budget, for example, is made available specifically for a so-called “Best Effort” data flow, then this budget cannot be used to the same extent for a different data flow, for example a so-called “real-time” data flow. Differentiated registration of transmission data is therefore necessary, whereby the individual data flows within a Layer 2/PDP context are differentiated. These individual data flows implement transactions of an application between two or more IP terminal points. A control function, known as an IP flow function, is defined in GPRS for this purpose. In this concept, the problem of allocating budgets to the individual data flows now arises. Furthermore, the requirement for a procedure in cases where the budget limit is reached, i.e. if the charge assessing computer or the online charging server cannot make any further budget available upon request, also becomes apparent. Until now the entire PDP context has been monitored by a control network node of the GPRS network, a so-called SGSN, and the call has been disconnected once the budget limit is reached.

If the so-called IP flow function were implemented, the budgets would be directly allocated to the individual data flows and the corresponding data flow would be interrupted if the budget limit were reached, whilst the remaining data flows would continue to remain in place.

This concept is, however, very rigidly related to the budget allocation and does not allow any flexibility once the budget limit is reached with regard to a specific data flow.

to the invention provides a method to distribute a budget that is available for a subscriber to the individual data flows, flexibly and at the same time in a controlled manner.

According to one embodiment of the invention, there is a method for monitoring and controlling a number of available decentralized IP budgets of a subscriber in a packet-based communications network during an online assessment of charges with limit value monitoring for data transmissions is provided, in which the number of available IP budgets are each allocated in a data-flow-specific manner to a data flow in a context that can be assigned to the subscriber, and a control function is provided in a network node of the communications network. The control function charges the data-flow-specific IP budget according to the resource utilization of a data flow based on charge assessment specifications issued by a charge-assessing computer during a resource utilization of a data flow in a context that can be assigned to the subscriber, and effects a partial or complete transmission of the IP budget between selected data flows on a case-by-case basis.

In a preferred embodiment of the invention, a GPRS network is used as a packet-based communications network. The control function is preferably located in a GGSN of the GPRS network. In the GPRS example, as already mentioned above, there are a number of data flows in a PDP context. As explained, a PDP context is an example of a so-called Layer 2 connection from a subscriber to the communications network. Similar Layer 2 connections also exist in a wireless local communications network, known as a WLAN (Wireless Local Area Network). The inventive method can be used for any IP flows/data flows.

In a preferred embodiment of the invention, in a first stage a first data flow is initially allocated a data-flow-specific, fixed IP budget. In a second stage, some or all of the data-flow-specific, fixed IP budget of the first data flow is transmitted by the control unit to a second data flow if appropriate transfer authorization and information is present in the charge assessing computer within the charge assessment specifications. This means that the charge assessing computer may issue the control function with an authorization to transfer an IP budget allocated to a first data flow “Flow 1” to a second data flow “Flow 2”. Each data flow has its own control unit for controlling and monitoring the data-flow-specific IP budget. By means of the control unit, it is possible for the IP budget currently still available for the respective data flow to be determined at any time. In order to transfer some or all of a data-flow-specific IP budget from one data flow to another data flow, the control function interacts with the control units to obtain information about the respective current status of the IP budget for the respective data flows.

In another preferred embodiment of the invention, some or all of the data-flow-specific IP budget of the first data flow is only transferred to a second data flow by the control unit if a data-flow-specific IP budget allocated to the second data flow has been completely used up.

In a further preferred embodiment of the invention, some or all of the data-flow-specific IP budget of the first data flow is transferred by the control unit to a second data flow if the second data flow belongs to a context that can be allocated to an IP address of the same subscriber.

Preferably, some or all of this data-flow-specific IP budget of the first data flow is transferred by the control unit to a second data flow if the second data flow belongs to a context that can be allocated to the same IP address of the subscriber.

It is preferable for some or all of this data-flow-specific IP budget of the first data flow only to be transferred by the control unit to a second data flow if the second data flow belongs to the same context as the first data flow. In the case of GPRS, then, this is a Layer 2 connection or a PDP context.

In a further preferred embodiment of the invention, the charge-assessing computer issues a transfer authorization within the charge assessment specifications by marking the first and the second data flow with a common identifier. This means that the charge-assessing computer marks, with a common identifier, the data flows between which some or all of the IP budget may be exchanged. A transfer of some or all of the respective IP budgets is effected without any weighting. This means that the data flows are assessed for charges in the same way without one being more expensive or cheaper than the other.

It is often also the case that different data flows are to be assessed for charges differently. It is therefore necessary, when some or all of the IP budget is transferred from one data flow to another data flow that is to be assessed for charges differently from the first, to implement a weighting of the part or entirety of the IP budget to be transferred. For this purpose the charge-assessing computer, according to the invention, specifies a data-flow-specific weighting factor for charge assessment of a data flow within its charge assessment specifications. By means of this weighting factor, when some or all of the IP budget is transferred it is possible for the weighting of this part to be changed according to the specifications for the data flow to which the part of the IP budget is to be transferred. For example, one data flow “Flow 1” may have a budget share of 100 kbytes and a Weighting Factor 1=10 bytes per unit, and a further data flow “Flow 2” may have a budget share of 200 kbytes and a Weighting Factor 2=30 kbytes per unit. If the IP budget of “Flow 1” is used up, then the control function—with the help of the information from the charge assessing computer with regard to the various weighting factors—may, for example, take 30 kbytes from “Flow 2” and convert it or multiply it by a factor “Weighting Factor 1/Weighting Factor 2”, and thus transfer 10 kbytes to the IP budget of “Flow 1”.

It is also possible for the total IP budget of a subscriber to be allocated initially to the control function, and for an IP budget—having been evaluated with the data-flow-specific weighting factor as part of the total IP budget—to be allocated by the control function to each data flow. Each data flow then has its own IP budget control unit again. The control function can obtain, from the individual data flows, the level of the remaining share of the IP budget allocated to the individual data flows in each case, request its return if necessary and distribute it to a different data flow with a new weighting. The total IP budget can thus be distributed flexibly independently of the charge-assessing computer. In this embodiment, a counter exists for each data flow in the data flow's own IP budget control unit. A data-flow-specific IP budget is weighted as part of the total IP budget and transferred to the data flow's own IP budget control unit, and the volume added up on the counter is regularly compared to the data-flow-specific IP budget as part of the total IP budget.

In a further preferred embodiment of the invention, priorities are additionally defined for the individual data flows. These priorities are taken into account during distribution of the budget. Thus, for example, a data flow that is marked for signaling information is treated with maximum lifetime, i.e. with high priority.

In a further preferred embodiment of the invention, the remaining IP budget of a data flow terminated by a mobile terminal of the subscriber is transferred to one or more of the remaining data flows as required. For this purpose the charge assessing computer notifies the control function whether, and to which data flow or data flows, the remaining IP budget is to be transferred, and in what proportion. The control function may, however, also store the IP budget and distribute it to a new data flow if one is added.

In another preferred embodiment of the invention, part of the existing budget is transferred to this data flow when a new data flow is added. For this purpose, the charge-assessing computer may specify from which budget the transfer is to be effected, and how much is to be transferred. The charge-assessing computer may also transfer new weighting factors for the data flows at this stage.

In a further preferred embodiment of the invention, the charge assessing computer requests the return of existing IP budgets when a data flow is added or removed, and transmits new IP budgets for data flows. This is particularly useful in order to adapt the total budget of the subscriber to the new conditions. This method may also be used when the budget limit of one of the data flows is reached. For this purpose, the charge-assessing computer may transmit a rule to the IP flow concerning the behavior when the Layer 2 connection is set up or at any stage during the connection.

In a further preferred embodiment of the invention, the charge-assessing computer—at any point during the connection—requests the return of remaining budgets and allocates new budgets to the data flows.

In a further preferred embodiment of the invention, the charge-assessing computer notifies the control function that, when a threshold value of any IP budget is reached, remaining IP budgets are to be transferred to the charge-assessing computer.

In a further preferred embodiment of the invention, the charge assessing computer notifies the control function that, when a threshold value of any IP budget is reached, a part of an IP budget or of all other IP budgets is to be transferred to the IP budget that is below the threshold value.

In a further embodiment of the invention, the charge assessing computer notifies the control function, by means of a table or a pointer to a position in a table, how the weighting of the IP budget of a data flow is to be changed in the event of a parameter change (e.g. QoS change) for this data flow.

### BRIEF DESCRIPTION OF THE DRAWINGS

The invention is described in more detail below with reference to exemplary embodiments and the drawings, in which:

FIG. 1 shows an embodiment of the invention.

FIG. 2 shows a different embodiment of the invention.

### DETAILED DESCRIPTION OF THE INVENTION

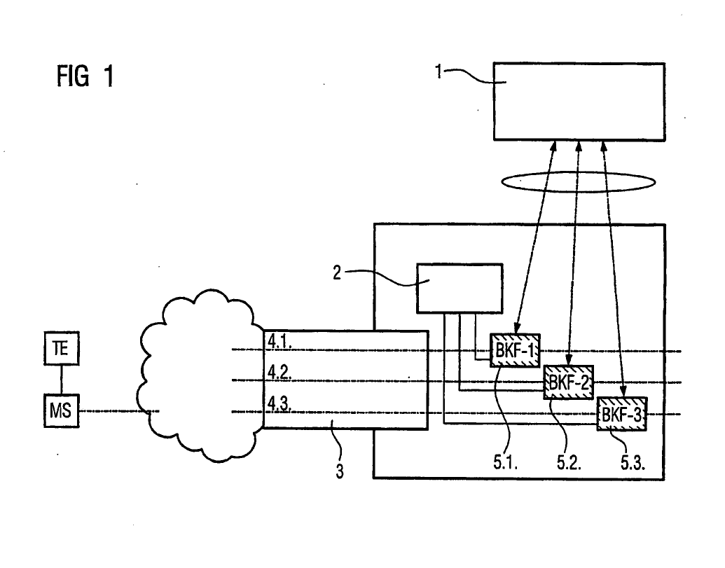

FIG. 1 shows an embodiment of the invention. The units of a communications network that are essential for the method are shown. A charge-assessing computer 1, a control function 2 provided in a network node of the communications network and a Layer 2 connection 3. The Layer 2 connection 3 is set up in the packet-based communications network for a subscriber TE by means of a mobile terminal MS via an access network. A plurality of different data flows 4.1., 4.2. and 4.3. is shown inside the Layer 2 connection 3. An IP budget 5. 1., 5. 2. and 5.3. is allocated in a data-flow-specific manner to each of these data flows, in each case with a corresponding budget control function BKF-1, BKF-2 and BKF-3. These IP budgets 5.1., 5.2. and 5.3. are allocated centrally by the charge-assessing computer 1 together with a transfer of corresponding charge assessment specifications or control information. In this embodiment of the inventive method the charge assessing computer 1 issues the control function 2 with a transfer authorization with regard to the transfer of some or all of the respective IP budget from one data flow to another data flow, whereby the charge assessing computer 1 marks, with a common identifier, the data flows between which the respective budgets are to be transferred, said common identifier here being illustrated by corresponding shading. The control function can accordingly transfer some or all of the budget 5.3. of the data flow 4.3. to the data flow 4.2.; likewise some or all of the budget 5.2. of the data flow 4.2. may be transferred to the data flow 4.3. This transfer of some or all of the respective budget is effected without any weighting. This means that the data flows with the same identifier are assessed for charging in the same way without one being more expensive or cheaper than the other. In this case, this means that the data flows 4.2. and 4.3. are assessed for charges equally.

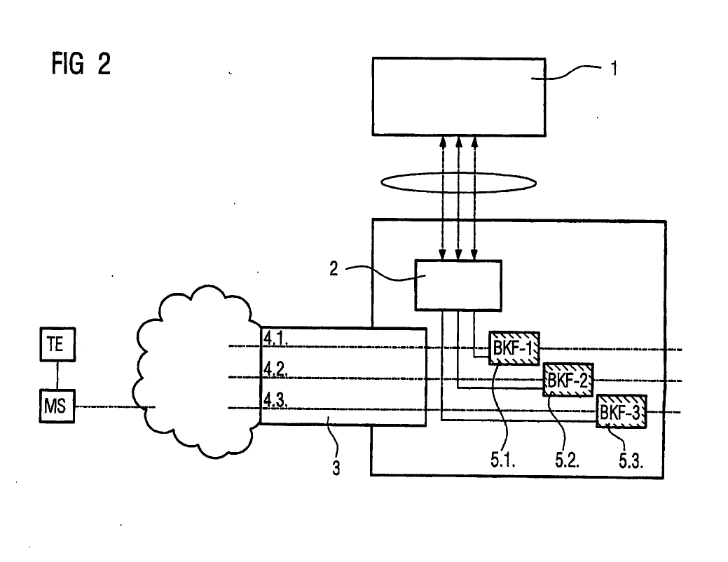

FIG. 2 shows another embodiment of the invention. A charge assessing computer 1, a control function 2 and a Layer 2 connection 3 are again shown. The Layer 2 connection 3 again contains a plurality of data flows 4.1.-4.3. These different data flows 4.1-4.3. are to be assessed for charges differently, and this is indicated by different shading. An IP budget 5.1., 5.2. and 5.3. is allocated in a data-flow-specific manner to each of these data flows. In this case, the IP budgets 5.1., 5.2. and 5.3. are allocated by the control function 2 on the basis of charge assessment specifications that were transferred to the control function 2 by the charge-assessing computer 1. To enable some or all or the respective IP budget also to be transferred between two data flows that are to be assessed for charges differently, such as—for example—between data flows 4.1. and 4.2., then the part of the budget 5.1 to be transferred must be weighted, for example during the transfer of the part of the budget 5.1. from data flow 4.1. to data flow 4.2. For this purpose the charge-assessing computer 1 provides the control function 2 with a data-flow-specific weighting factor 6.1. and a weighting factor 6.2. The weighting of the part of the budget 5.1 can be changed by means of the weighting factors 6.1. and 6.2. during the transfer of the part of the budget 5.1. to the data flow 4.2. For example, if the data flow 4.1. has a budget 5.1. of 200 kbytes and a weighting factor 6.1.=30 kbytes per unit, and the data flow 4.2. has a budget 5.2. of 100 kbytes with a weighting factor 6.2.=10 kbytes per unit, then the control function 2 can take—for example—30 kbytes from the data flow 4.1 with the help of the weighting factors 6.1. and 6.2. and convert it or multiply it by a conversion factor 6.2./6.1.=1/3, and thus transfer 10 kbytes to data flow 4.2.

1. A method for monitoring and controlling a number of available decentralized IP budgets of a subscriber in a packet-based communications network during an online assessment of charges for data transmissions, comprising:
allocating a plurality of available IP budgets in a data-flow-specific manner to a data flow in a context that can be assigned to the subscriber;
providing a higher-order control function in a network node of the communications network, the control function charging the data-flow-specific IP budget according to a resource use of a data flow based on charge assessment specifications issued by a charge-assessing computer during a resource utilization of the data flow in a context that can be assigned to the subscriber; and
effecting a partial or complete transmission of the IP budget between selected data flows on a case-by-case basis, whereby the control function effects a reallocation or transfer of the IP budget according to the specifications of the charge-assessing computer.

2. The method according to claim 1, wherein when a data flow is added or removed, the charge assessing computer or the control function requests a return of allocated IP budgets according to the charge assessment specifications of the charge-assessing computer and reallocates the IP budgets.

3. The method according to claim 1, wherein the charge assessing computer or the control function requests a return of allocated IP budgets at a point in time specified by the charge-assessing computer according to the charge assessment specifications of the charge-assessing computer, and reallocates the IP budgets.

4. The method according to claim 1, wherein some or all of the data-flow-specific IP budget of a first data flow is transferred by the control unit according to the charge assessment specifications of the charge assessing computer to a second data flow if a data-flow-specific IP budget allocated to the second data flow reaches a threshold value or is completely used up.

5. The method according to claim 1, wherein some or all of the data-flow-specific IP budget of a first data flow is transferred by the control unit to a second data flow if the second data flow belongs to a context that can be allocated to an IP address of a same subscriber.

6. The method according to claim 1, wherein some or all of the data-flow-specific IP budget of the first data flow is transferred by the control unit to a second data flow if the second data flow belongs to a context that can be allocated to a same IP address of the subscriber.

7. The method according to claim 1, wherein some or all of the data-flow-specific IP budget of a first data flow is transferred by the control unit to a second data flow if the second data flow belongs to the same context as the first data flow.

8. The method according to claim 1, wherein the charge-assessing computer issues a transfer authorization, within the charge assessment specifications, between a first and a second data flow by marking the first and the second data flow with a common identifier.

9. The method according to claim 1, wherein a data-flow-specific weighting factor is specified by the charge-assessing computer for charge assessment of a data flow.

10. The method according to claim 9, wherein a data-flow-specific weighting factor is specified by the charge-assessing computer for charge assessment of a data flow by means of a table or pointer to a position in a table.

11. The method according to claim 1, wherein a GPRS network is used as the packet-based communications network.

12. The method according to claim 11, wherein the control function is located in a GGSN.

13. The method according to claim 1, wherein the control function requests a return of the IP budgets of all other data flows when a threshold value of a data-flow-specific IP budget of any data flow is reached, and transfers them to the charge assessing computer.

14. The method according to claim 1, wherein part of a data-flow-specific IP budget of a data flow terminated by the subscriber is transferred by the control function to one or more existing or new data flows.

15. The method according to claim 1, wherein when a new data flow is added by the control function according to the charge assessment specifications of the charge-assessing computer, at least part of the IP budget of at least one existing data flow is transferred to the new data flow.
